(19) United States
(12) Patent Application Publication
(10) Pub. No.: US 2019/0376518 A1
(43) Pub. Date: Dec. 12, 2019

(54) Housing Seal Structure And Fluid Machine Having Same

(71) Applicant: SANDEN AUTOMOTIVE COMPONENTS CORPORATION, Isesaki-shi (JP)

(72) Inventors: Yuri TATENO, Isesaki-shi (JP); Masashi YAGUCHI, Isesaki-shi (JP); Jiro IIZUKA, Isesaki-shi (JP); Satoshi ANDO, Isesaki-shi (JP)

(73) Assignee: SANDEN AUTOMOTIVE COMPONENTS CORPORATION, Gunma (JP)

(21) Appl. No.: 16/331,857

(22) PCT Filed: Sep. 7, 2017
(86) PCT No.: PCT/JP2017/033168

§ 371 Date: Mar. 8, 2019

(30) Foreign Application Priority Data
Sep. 23, 2016 (JP) 2016-185335

(51) Int. Cl. F04C 27/00; F04C 18/02; F16J 15/10; F16J 15/14

(52) U.S. Cl. CPC F04C 27/00; F04C 18/0215; F04C 2240/805; F16J 15/14; F04C 2240/30; F16J 15/10

(57) ABSTRACT

To provide a housing seal structure in which the sealability between housings using an O-ring is improved. The housing seal structure seals joining portions 57 and 59 of a fixed scroll 24 and a front housing 4, respectively, which are joined to each other, by an O-ring 62 and is provided with a stepped coated portion 64 formed in the joining portion of the front housing on the outside relative to an O-ring groove 63 accommodating the O-ring, having a predetermined width, and extending to the outer peripheral contour of the front housing, a liquid sealing agent 68 charged into the coated portion to be applied thereto, and a contact portion 67 which is formed between the O-ring groove and the coated portion and which the joining portions of the fixed scroll and the front housing contact.

### TECHNICAL FIELD

The present invention relates to a housing seal structure for avoiding the occurrence of corrosion to joining portions of housings sealed by an O-ring and a fluid machine having the same.

### BACKGROUND ART

Heretofore, when a scroll type compressor is configured, for example, a fixed scroll as a first housing is fastened to a front housing as a second housing with a plurality of bolts to be joined to each other. However, the inside becomes high pressure and the outside becomes atmospheric pressure, and therefore joining portions of both the housings are usually sealed by an O-ring. In this case, the surface pressure of the joining portions of both the housings is lower in portions separated from the bolts than in portions immediately under the bolts where the bolt axial force is applied, and therefore a gap has been generated between both the housings in such places in some cases.

Thus, a seal structure in which a resin seal is applied to the outside of an O-ring has been developed (for example, see Patent Document 1). There has also been a seal structure in which joining portions of housings are sealed by applying a liquid sealing agent (for example, see Patent Document 2).

### CITATION LIST

### Patent Documents

Patent Document 1: Japanese Patent Application Publication No. 2001-349432

Patent Document 2: Japanese Patent No. 5260198

### SUMMARY OF THE INVENTION

### Problems to be Solved by the Invention

However, in FIG. 3(b) of Patent Document 1 described above, the outer peripheral contour of the joining portion of each housing has been obliquely separated, and then the resin seal has been applied thereto, and therefore sufficient sealability has not been able to be obtained on the outside of the O-ring. Moreover, the housings have been brought into contact with each other for metal sealing between the O-ring and the resin seal. However, the contact has been line contact, and therefore there has been a risk that the resin seal has intruded into an O-ring groove, and then solidified to deteriorate the sealability of the O-ring itself.

The present invention has been made in order to solve the conventional technical problems. It is an object of the present invention to provide a housing seal structure in which the sealability between housings using an O-ring is improved and a fluid machine using the same.

### Means for Solving the Problems

A housing seal structure of the present invention seals joining portions of a first housing and a second housing, which are joined to each other, by an O-ring and is provided with a stepped coated portion formed in the joining portions or the joining portion of the first housing on the outside relative to an O-ring groove accommodating the O-ring and/or the second housing, having a predetermined width, and extending to the outer peripheral contour of each of the housings, a liquid sealing agent charged into the coated portion to be applied thereto, and a contact portion which is formed between the O-ring groove and the coated portion and in which the joining portion of each of the housings contacts.

According to the housing seal structure of the invention of Claim 2, the joining portions of the housings are brought into surface contact with each other in the contact portion in the invention described above.

According to the housing seal structure of the invention of Claim 3, the step size of the coated portion is 0.1 mm or more and 0.3 mm or less in each invention described above.

According to the housing seal structure of the invention of Claim 4, the housings are fastened to each other with a bolt, the O-ring groove is formed on the inside relative to the bolt, and the coated portion is formed over the circumferential direction on the outside relative to the bolt in each invention described above.

According to the housing seal structure of the invention of Claim 5, the housings are fastened to each other with a bolt, the O-ring groove is formed on the inside relative to the bolt, and the coated portion is formed in a portion other than a portion where the bolt is located in the inventions of Claims 1 to 3.

According to the housing seal structure of the invention of Claim 6, the width of the contact portion is smaller than the width of the O-ring groove at least in the portion other than the portion where the bolt is located in the invention of Claim 4 or 5.

According to the housing seal structure of the invention of Claim 7, the liquid sealing agent is applied from the coated portion to the outer surface of each of the housings and covers the outer surface of each of the housings with a size larger than the step size of the coated portion in each invention described above.

A fluid machine of the invention of Claim 8 is obtained by joining a fluid mechanism unit as the first housing and a front housing as the second housing of each invention described above.

### Advantageous Effect of the Invention

According to the present invention, a housing seal structure in which joining portions of a first housing and a second housing, which are joined to each other, are sealed by an O-ring is provided with a stepped coated portion formed in the joining portions or the joining portion of the first housing on the outside relative to an O-ring groove accommodating the O-ring and/or the second housing, having a predetermined width, and extending to the outer peripheral contour of each of the housings, a liquid sealing agent charged into the coated portion to be applied thereto, and a contact portion which is formed between the O-ring groove and the coated portion and in which the joining portion of each the housings contacts. Therefore, the liquid sealing agent improves the sealability on the outside relative to the O-ring and prevents the intrusion of salt water or the like from the joining portions between the housings, so that an inconvenience that rust caused by the corrosion of the housing proceeds to the O-ring can be effectively avoided.

In this case, the coated portion is configured to be formed in the joining portions or the joining portion in the first housing and/or the second housing and to have a stepped shape having a predetermined width and extending to the outer peripheral contour of each of the housings, and therefore the coating thickness of the liquid sealing agent can be secured and a gap or a shift between the housings can be effectively sealed.

Moreover, when the joining portions of the housings are brought into surface contact with each other in the contact portion as with the invention of Claim 2, the sealability of the joining portions of the housings is further improved and the inconvenience that the liquid sealing agent intrudes into the O-ring can also be avoided beforehand.

In this case, the step size of the coated portion is desirably set to 0.1 mm or more and 0.3 mm or less as with the invention of Claim 3.

In this case, in the case where the housings are fastened to each other with a bolt as with the invention of Claim 4, when the O-ring groove is formed on the inside relative to the bolt and the coated portion is formed over the circumferential direction on the outside relative to the bolt, the joining portions can be sealed by the liquid sealing agent from the outside in such a manner that the O-ring and the bolts are enclosed, so that the intrusion of rust into the joining portions can be much more effectively prevented.

On the other hand, when the O-ring groove is formed on the inside relative to the bolts and the coated portion is formed in portions other than portions where the bolts are located as with the invention of Claim 5, the coated portion to which the liquid sealing agent is applied is not formed immediately under the bolt where the surface pressure is obtained, so that an inconvenience that the maximum outer diameter of the housing increases can be avoided.

Moreover, when the width of the contact portion is smaller than the width of the O-ring groove at least in the portions other than the portions where the bolts are located as with the invention of Claim 6, high surface pressure of the contact portion can be stably obtained in portions separated from the bolts, so that the surface roughness (unevenness) of the joining portions of the housings is easily buried.

Furthermore, when the liquid sealing agent is applied over the outer surface of each of the housings from the coated portion and coats the outer surface of each of the housings with a size larger than the step size of the coated portion as with the invention of Claim 7, the joining portions of the housings can be covered from the outside by the liquid sealing agent, so that the intrusion of rust can be much more effectively prevented.

In the fluid machine obtained by joining the fluid mechanism unit as the first housing and the front housing as the second housing as with the invention of Claim 8, the seal structure of the present invention is very effective.

### BRIEF DESCRIPTION OF THE DRAWINGS

FIG. 1 is a vertical cross-sectional side view of a scroll type compressor of one embodiment to which the present invention is applied.

FIG. 2 is a plan view of a scroll unit of the scroll type compressor of FIG. 1 when a fixed scroll configuring the scroll unit and a front housing are schematically illustrated.

FIG. 3 is a cross-sectional view along the A-A line of a state before the fixed scroll and the front housing of FIG. 2 are fastened and joined.

FIG. 4 is a plan view of the front housing of FIG. 3 (Embodiment 1).

FIG. 5 is a cross-sectional view of a joining portion of the fixed scroll and the front housing of FIG. 3.

FIG. 6 is a plan view of a front housing of a scroll type compressor of another Embodiment of the present invention (Embodiment 2).

### MODE FOR CARRYING OUT THE INVENTION

Hereinafter, one embodiment of the present invention is described with reference to the drawings.

### Embodiment 1

A scroll type compressor 1 as one Embodiment of a fluid machine is a refrigerant compressor incorporated in a refrigerant circuit of an air-conditioning system of vehicles and sucks and compresses a refrigerant as a working fluid from the refrigerant circuit and then discharges the same to the refrigerant circuit again. A lubricating oil is filled into the scroll type compressor 1. The oil lubricates a bearing or various sliding portions and also seals the sliding surfaces.

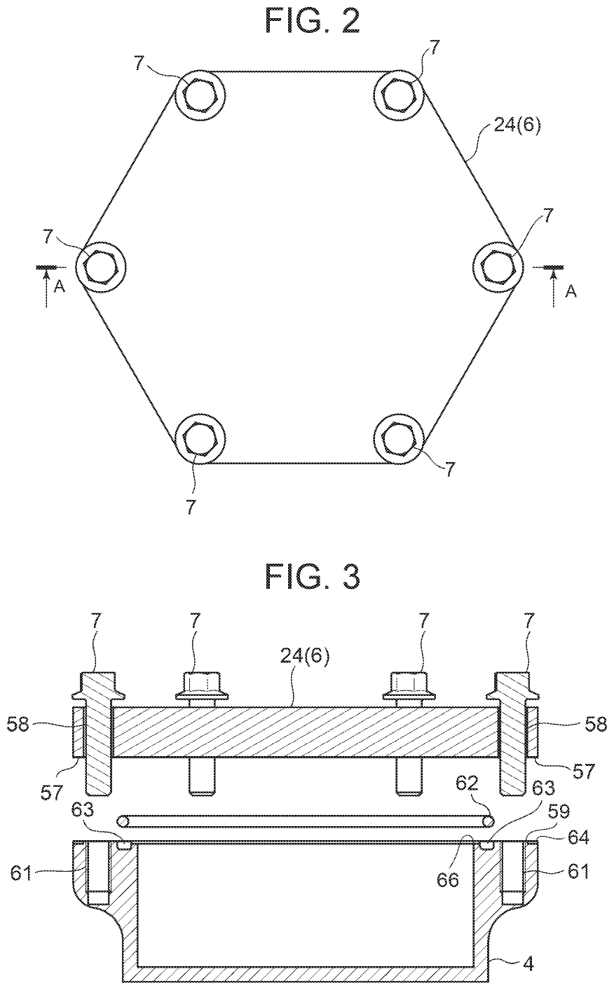

The scroll type compressor 1 is provided with a rear housing 2 and a front housing 4, in which a scroll unit 6 as a fluid mechanism unit in the present invention is disposed between the rear housing 2 and the front housing 4, the rear housing 2 and the scroll unit 6 are fastened to each other with a plurality of bolts 5, and a fixed scroll 24 (described later) configuring the scroll unit 6 and the front housing 4 are fastened to each other with a plurality of bolts 7 (FIG. 2) as described later.

In the front housing 4, a driving shaft 8 is horizontally disposed and the driving shaft 8 has a large diameter shaft portion 10 located on the scroll unit 6 side and a small diameter shaft portion 12 projecting from the front housing 4. The large diameter shaft portion 10 is rotatably supported by the front housing 4 through a needle bearing 14 and the small diameter shaft portion 12 is rotatably supported by the front housing 4 through a ball bearing 16.

To the projection end of the small diameter shaft portion 12, a driving pulley 20 containing an electromagnetic clutch 18 is attached. The driving pulley 20 is rotatably supported by the front housing 4 through a bearing 22. To the driving pulley 20, the power of an engine of a vehicle is transmitted through a driving belt, which is not illustrated, and the rotation of the driving pulley 20 can be transmitted to the driving shaft 8 through the electromagnetic clutch 18. More specifically, when the electromagnetic clutch 18 is turned ON during the driving of the engine, the driving shaft 8 integrally rotates with the driving pulley 20.

On the other hand, the scroll unit 6 is configured to be provided with a fixed scroll 24 held between the rear housing 2 and the front housing 4 and a movable scroll 26 attached to the fixed scroll 24 in such a manner as to be engaged therewith. When rotated and driven by the driving shaft 8, the movable scroll 26 revolves and turns with respect to the fixed scroll 24, so that the fixed scroll 24 and the movable scroll 26 are engaged to cooperate with each other, whereby a compression chamber 28 as a pressure chamber of a refrigerant containing oil is formed thereinside. The capacity of the compression chamber 28 is increased/decreased in connection with the revolution and turning movement of the movable scroll 26 to the fixed scroll 24.

In order to give the revolution and turning movement to the movable scroll 26, a boss 32 projectingly disposed on a substrate 30 of the movable scroll 26 and the large diameter shaft portion 10 of the driving shaft 8 are coupled to each other through a crank pin 34, an eccentric bushing 36, and a needle bearing 38. To the eccentric bushing 36, a counterweight 40 is attached. Between the movable scroll 26 and the front housing 4, an annular thrust plate 42 supporting the movable scroll 26 so as to be able to revolve and turn is disposed.

Between the fixed scroll 24 and an end wall 46 of the rear housing 2, a discharge chamber 48 is formed. The fixed scroll 24 has a discharge hole 56 causing the compression chamber 28 and the discharge chamber 48 to communicate with each other. In the discharge chamber 48, a discharge valve 55 opening and closing the discharge hole 56 is disposed. The opening and closing of the discharge valve 55 is regulated by the stopper plate 54.

In the scroll type compressor 1, the movable scroll 26 revolves and turns without rotation on its axis in connection with the rotation of the driving shaft 8. Such revolution movement of the movable scroll 26 causes a process of sucking a refrigerant from a suction port, which is not illustrated, formed in the front housing 4 into the compression chamber 28 or a compression and discharging process of the sucked refrigerant, which results in the fact that a high-pressure refrigerant is discharged from the scroll type compressor 1 sequentially via the discharge hole 56, the discharge chamber 48, and a discharge port, which is not illustrated, formed in the rear housing 2 from the compression chamber 28.

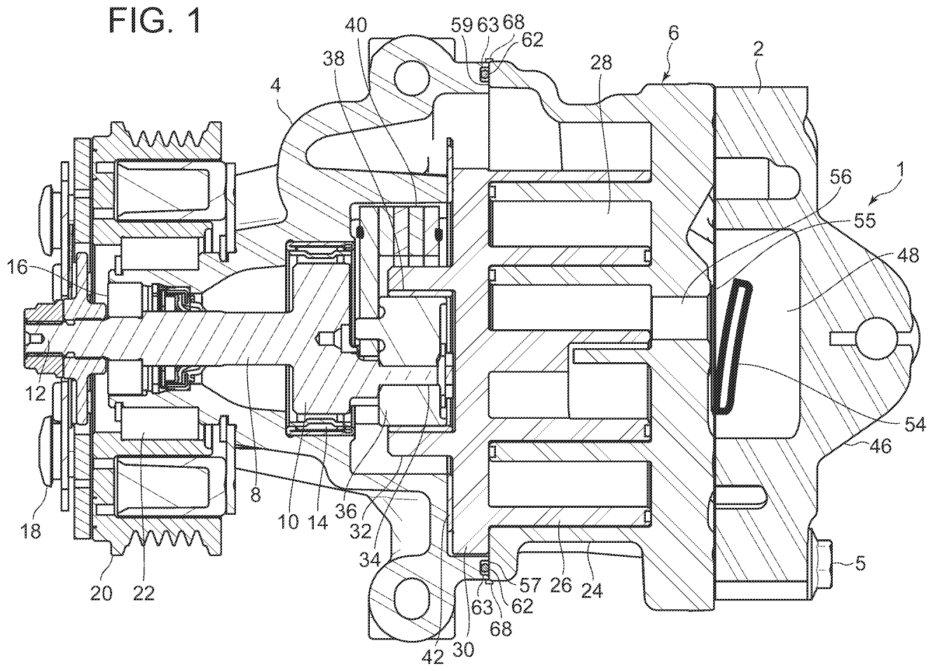

Next, the fastening of the fixed scroll 24 of the scroll unit 6 and the front housing 4 by the bolts 7 and the seal structure are described in detail with reference to FIG. 2 to FIG. 5. Each drawing does not illustrate detailed shapes of the fixed scroll 24 and the front housing 4 as illustrated in FIG. 1 and schematically illustrates them.

The fixed scroll 24 of the scroll unit 6 as Embodiment of the fluid mechanism unit serves as the first housing in the housing seal structure of the present invention and the front housing 4 serves as the second housing. In the case of Embodiment, the fixed scroll 24 (same applies to the movable scroll 26) is configured by aluminum forging and the front housing 4 is configured by aluminum casting. Therefore, the fixed scroll 24 (first housing) has hardness higher than that of the front housing 4 (second housing).

In a joining portion 57 of an outer peripheral portion of the fixed scroll 24, a plurality of bolt holes 58 into which the bolts 7 are passed through are formed. In a joining portion 59 of an outer peripheral portion of the front housing 4, a plurality of bolt holes 61 (female screws) into which the bolts 7 are screwed are formed in agreement with the positions of the bolt holes 58 of the fixed scroll 24. Moreover, an O-ring groove 63 accommodating an O-ring 62 is formed over the circumferential direction (entire circumference) in the joining portion 59 inside the bolt holes 61 of the front housing 4. The O-ring 62 contains polymer materials, such as rubber, and has an annular shape.

Furthermore, a coated portion 64 is formed over the circumferential direction in the joining portion 59 on the outside of the bolt holes 61 of the bolts 7 located outside relative to the O-ring groove 63 of the O-ring 62. The coated portion 64 is formed into a stepped shape, having a predetermined width and extending to the outer peripheral contour of the front housing 4. The step size thereof is set to 0.1 mm or more and 0.3 mm or less in Embodiment. Herein, a liquid sealing agent 68 described later is charged into the coated portion 64 to be applied thereto. As the liquid sealing agent 68, a quick-drying material containing silicone as the main component, having an elongation of 170% or more, and excellent in engine oil resistance and LLC (cooling water for automobiles) resistance is adopted in Embodiment.

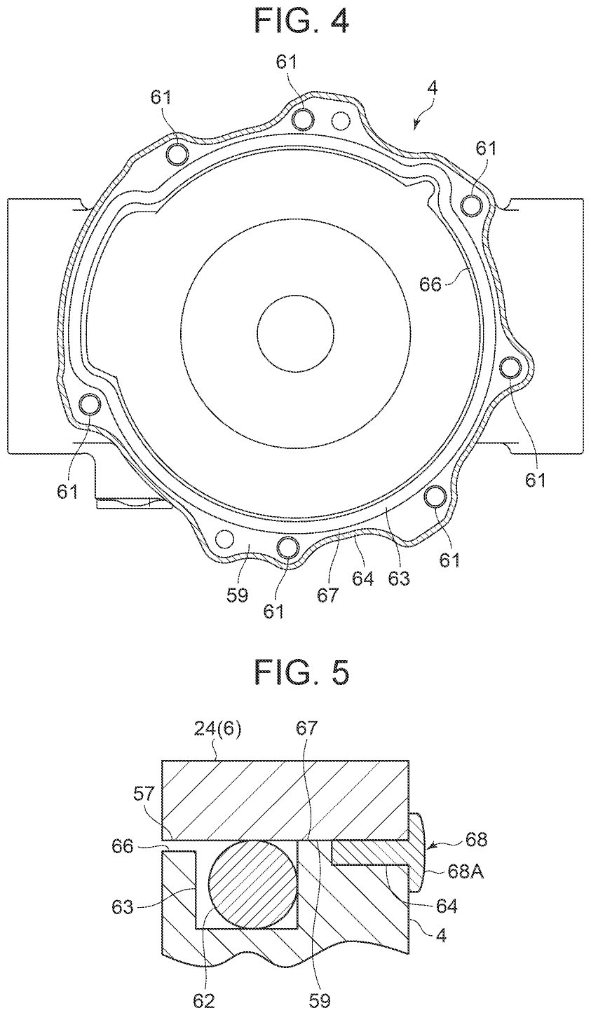

Furthermore, between the O-ring groove 63 and the coated portion 64, a contact portion 67 where the joining portion 57 of the fixed scroll 24 and the joining portion 59 of the front housing 4 contact is formed over the circumferential direction. The joining portion 57 of the fixed scroll 24 and the joining portion 59 of the front housing 4 are brought into surface contact with each other in the contact portion 67 as illustrated in FIG. 5 and the width is made smaller than the width of the O-ring groove 63 in portions (portion between the bolt holes 61 and 61) other than the portions where the bolt holes 61 of the bolts 7 are located as illustrated in FIG. 4. The joining portion 59 inside the O-ring groove 63 of the O-ring 62 is formed into a step-down shape over the circumferential direction (entire circumference) as illustrated in FIG. 5 and a step-down portion 66 is formed therein.

In the configuration described above, the O-ring 62 is disposed in the O-ring groove 63 and a predetermined amount of the liquid sealing agent 68 (amount that the liquid sealing agent 68 protrudes from the inside of the coated portion 64 to the outer peripheral contour side in the state where the fixed scroll 24 and the front housing 4 are fastened to each other) is charged into the coated portion 64 to be applied thereto. In the state, the joining portion 57 of the fixed scroll 24 is superposed on the joining portion 59 of the front housing 4 so as to cover the same, each bolt hole 58 of the fixed scroll 24 is made in agreement with each bolt hole 61 of the front housing 4, and then the bolt 7 is inserted into each bolt hole 58 to be screwed into each bolt hole 61 of the front housing 4 and tightened, whereby the fixed scroll 24 and the front housing 4 are fastened to each other.

Thus, the fixed scroll 24 and the front housing 4 are fastened to each other and the O-ring 62 in the O-ring groove 63 formed in the joining portion 59 of the front housing 4 is brought into close contact with the joining portion 57 of the fixed scroll 24, and therefore the joining portions 57 and 59 of the fixed scroll 24 and the front housing 4, respectively, are first sealed at the position of the O-ring 62.

Moreover, the joining portion 57 of the fixed scroll 24 is brought into surface contact with the joining portion 59 of the front housing 4 in the contact portion 67. In the contact portion 67, the joining portion 57 of the fixed scroll 24 and the joining portion 59 of the front housing 4 are metal-sealed.

Furthermore, the liquid sealing agent 68 is charged into the coated portion 64 with no gap, an excess of the liquid sealing agent 68 protrudes from the outer peripheral contours of the fixed scroll 24 and the front housing 4 (68A indicates the protrusion portion), and the excess of the liquid sealing agent 68 is cured in a state of covering the outer surfaces of the fixed scroll 24 and the front housing 4 as illustrated in FIG. 5, for example. The width size of the protrusion portion 68A is set to be larger than the step size of the coated portion 64 (FIG. 5).

Thus, the stepped coated portion 64 formed in the joining portion 59 of the front housing 4 on the outside relative to the O-ring groove 63 accommodating the O-ring 62, having a predetermined width, and extending to the outer peripheral contour of the front housing 4, the liquid sealing agent 68 charged into the coated portion 64 to be applied thereto, and the contact portion 67 which is formed between the O-ring groove 63 and the coated portion 64 and which the joining portion 57 of the fixed scroll 24 and the joining portion 59 of the front housing 4 contact are provided, and therefore the liquid sealing agent 68 improves the sealability on the outside relative to the O-ring 62 and prevents the intrusion of salt water or the like from a gap between the joining portion 57 of the fixed scroll 24 and the joining portion 59 of the front housing 4, so that the inconvenience that rust caused by the corrosion of the fixed scroll 24 or the front housing 4 proceeds to the O-ring 62 can be effectively avoided.

In this case, the coated portion 64 is configured to be formed in the joining portion 59 of the front housing 4 and have a stepped shape, having a predetermined width and extending to the outer peripheral contour of the front housing 4, and therefore the coating thickness of the liquid sealing agent 68 can be secured and a gap or a shift between the fixed scroll 24 and the front housing 4 can be effectively sealed.

Moreover, the joining portion 57 of the fixed scroll 24 and the joining portion 59 of the front housing 4 are brought into surface contact with each other in the contact portion 67 in Embodiment, and therefore the sealability between the joining portions 57 and 59 is further improved and the inconvenience that the liquid sealing agent 68 intrudes into the O-ring 62 can also be avoided beforehand.

Moreover, the fixed scroll 24 and the front housing 4 are fastened to each other with the bolts 7, the O-ring groove 62 is formed on the inside relative to the bolt holes 61 of the bolts 7, and the coated portion 64 is formed over the circumferential direction on the outside relative to the bolt holes 61 of the bolts 7 in Embodiment, and therefore the joining portions 57 and 59 can be sealed from the outside by the liquid sealing agent 68 in such a manner that that the O-ring 62 and the bolts 7 (bolt holes 61) are enclosed, so that the intrusion of rust into the joining portions 57 and 59 can be much more effectively prevented.

Moreover, the width of the contact portion 67 is made smaller than the width of the O-ring groove 63 in portions other than the portions where the bolt holes 61 of the bolts 7 are located in Embodiment, and therefore high surface pressure of the contact portion 67 can be stably obtained in portions separated from the bolts 7, so that the surface roughness (unevenness) of the joining portions 57 and 59 of the fixed scroll 24 and the front housing 4, respectively, is easily buried.

Furthermore, the liquid sealing agent 68 is applied over the outer surface of the fixed scroll 24 or the front housing 4 while protruding from the coated portion 64 and coats the outer surface of the fixed scroll 24 or the front housing 4 with a size larger than the step size of the coated portion 64, and therefore the joining portions 57 and 59 can be covered from the outside by the liquid sealing agent 68, so that the intrusion of rust can be much more effectively prevented.

### Embodiment 2

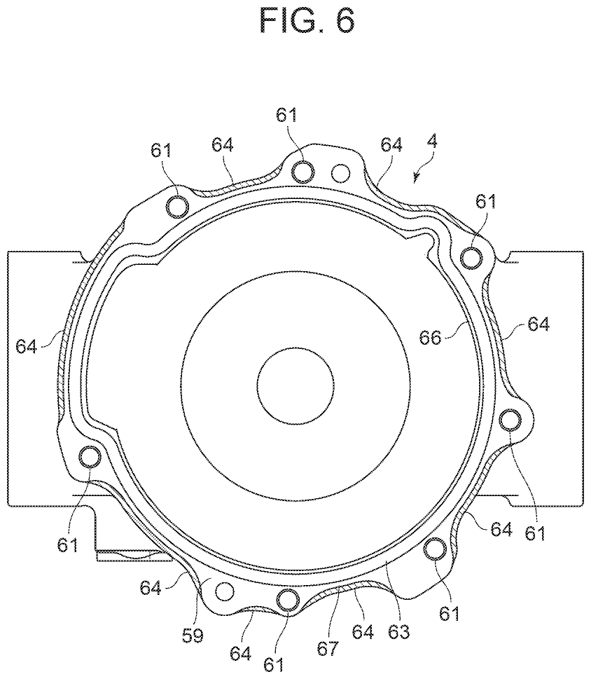

Next, FIG. 6 illustrates a plan view of a front housing 4 of a scroll type compressor 1 of another Embodiment of the present invention. In this case, a coated portion 64 is formed in portions other than portions where bolt holes 61 of bolts 7 are located. Herein, in the case where the sealability can be secured even when a liquid sealing agent 68 is not applied because sufficient surface pressure is obtained in portions immediately under the bolts 7, the coated portion 64 is not formed in the portions where the bolt holes 61 are located as illustrated in FIG. 6. Thus, the inconvenience that the maximum outer diameter of the front housing 4 increases can be avoided.

Although the coated portion 64 is formed in the front housing 4 as the second housing in Embodiment, the coated portion may be formed in a fixed scroll 24 which is the first housing or may be formed to face both of them without being limited thereto.

Moreover, the present invention is applied to the scroll type compressor in which the front housing is fastened to the fixed scroll configuring the scroll unit in Embodiment. However, in a scroll type compressor of a structure in which a fixed scroll and a movable scroll are accommodated in a fluid mechanism housing to configure a scroll unit and the fluid mechanism housing and a front housing are fastened, the fluid mechanism housing configuring the scroll unit (fluid mechanism unit) serves as the first housing.

Furthermore, the housing seal structure is applied to the scroll type compressor in Embodiment. However, the inventions of Claims 1 to 7 are effective without being limited thereto when various metal housings are sealed. Moreover, the fluid machine to which the present invention is applied is not limited to the scroll type compressor of Embodiment and is also effective for a swash plate type compressor provided with a swash plate type compression unit or a rotary type compressor provided with a rotary type compression unit and, in addition thereto, the present invention is also applicable to an expansion machine and the like.

### DESCRIPTION OF REFERENCE NUMERALS

1 scroll type compressor
4 front housing (second housing)
6 scroll unit (compression unit, first housing)
7 bolt
24 fixed scroll (first housing)
57, 59 joining portion
58, 61 bolt hole
62 O-ring
63 O-ring groove
64 coated portion
66 step-down portion
67 contact portion
68 liquid sealing agent

1. A housing seal structure in which joining portions of a first housing and a second housing, which are joined to each other, are sealed by an O-ring, the housing seal structure comprising:
a stepped coated portion formed in the joining portions or the joining portion of the first housing on an outside relative to an O-ring groove accommodating the O-ring and/or the second housing, having a predetermined width, and extending to an outer peripheral contour of each of the housings;
a liquid sealing agent charged into the coated portion to be applied to the coated portion; and
a contact portion which is formed between the O-ring groove and the coated portion and in which the joining portion of each of the housings contacts.

2. The housing seal structure according to claim 1, wherein
the joining portions of the housings are brought into surface contact with each other in the contact portion.

3. The housing seal structure according to claim 1, wherein
a step size of the coated portion is 0.1 mm or more and 0.3 mm or less.

4. The housing seal structure according to claim 1, wherein
the housings are fastened to each other with a bolt,
the O-ring groove is formed on an inside relative to the bolt, and
the coated portion is formed over a circumferential direction on an outside relative to the bolt.

5. The housing seal structure according to claim 1, wherein
the housings are fastened to each other with a bolt, the O-ring groove is formed on an inside relative to the bolt, and
the coated portion is formed in a portion other than a portion where the bolt is located.

6. The housing seal structure according to claim 4, wherein
a width of the contact portion is smaller than a width of the O-ring groove at least in the portion other than the portion where the bolt is located.

7. The housing seal structure according to claim 1, wherein
the liquid sealing agent is applied from the coated portion to an outer surface of each of the housings and covers the outer surface of each of the housings with a size larger than the step size of the coated portion.

8. A fluid machine, comprising:
the housing seal structure according to claim 1, wherein
the fluid machine is obtained by joining a fluid mechanism unit as the first housing and a front housing as the second housing.
